(19) United States
(12) Patent Application Publication
(10) Pub. No.: US 2012/0113311 A1
(43) Pub. Date: May 10, 2012

(54) IMAGE CAPTURE DEVICE AND METHOD FOR ADJUSTING FOCAL POINT OF LENS OF IMAGE CAPTURE DEVICE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/151,260

(22) Filed: Jun. 1, 2011

(30) Foreign Application Priority Data
Nov. 8, 2010 (TW) 99138367

(51) Int. Cl. H04N 5/232

(52) U.S. Cl. 348/345; 348/E05.045

(57) ABSTRACT

A method for adjusting a focal point of a lens of an image capture device obtains a plurality of images of a monitored scene captured by a lens of the image capture device, and detects a motion area in the monitored scene from the obtained images. The method further adjusts a focal point of the lens of the image capture device to a specified position of the motion area upon the condition that the motion area has been detected.

### BACKGROUND

1. Technical Field

Embodiments of the present disclosure relate to security surveillance technology, and particularly to an image capture device and method for adjusting the focal point of a lens of the image capture device.

2. Description of Related Art

Image capture devices have been used to perform security surveillance by capturing images of monitored scenes, and sending the captured images to a monitor computer. However, the orientation of the image capture device cannot be changed when the image capture device is being used. If the orientation of the image capture device is changed, the focal point of a lens of the image capture device may not be correct for maximum clarity in relation to a different scene, and the images captured by the lens may be fuzzy, thereby adversely influencing monitor effectiveness. Therefore, an efficient method for adjusting the focal point of a lens of the image capture device is desired.

### BRIEF DESCRIPTION OF THE DRAWINGS

FIG. 1 is a block diagram of one embodiment of an image capture device.

FIG. 2 is a block diagram of one embodiment of a focus adjustment system of the image capture device.

FIG. 3 is a flowchart of one embodiment of a method for adjusting the focal point of a lens in the image capture device.

### DETAILED DESCRIPTION

All of the processes described below may be embodied in, and fully automated via, functional code modules executed by one or more general purpose electronic devices or processors. The code modules may be stored in any type of non-transitory readable medium or other permanent storage device. Some or all of the methods may alternatively be embodied in specialized hardware. Depending on the embodiment, the non-transitory readable medium may be a hard disk drive, a compact disc, a digital video disc, a tape drive or other suitable storage medium.

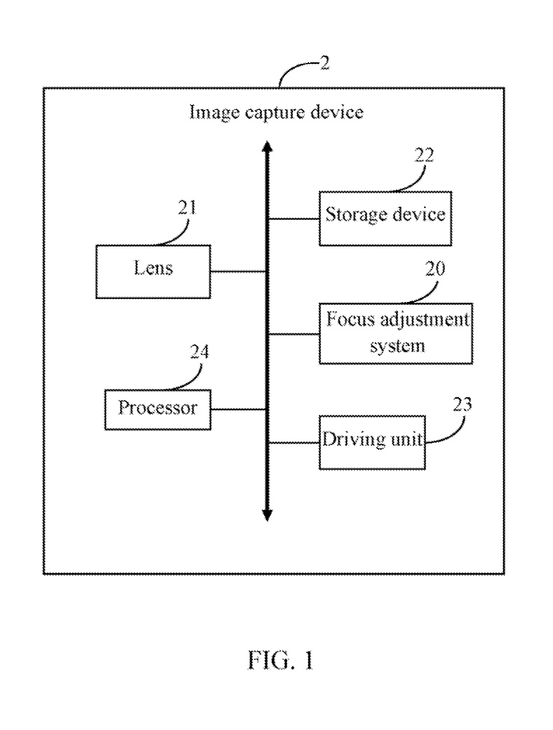

FIG. 1 is a block diagram of one embodiment of an image capture device 2. In one embodiment, the image capture device 2 includes a focus adjustment system 20, a lens 21, a storage device 22, a driving unit 23, and at least one processor 24. The focus adjustment system 20 may be used to detect a motion area in a monitored scene from images captured by the lens 21, and further to adjust the focal point of the lens 21 of the image capture device 2 to focus on the motion area. A detailed description will be given in the following paragraphs.

In one embodiment, the image capture device 2 may be a speed dome camera or a pan/tilt/zoom (PTZ) camera, for example. The monitored scene may be the interior of a warehouse or other high-security location.

The lens 21 captures a plurality of images of the monitored scene. In one embodiment, the lens 21 may include a charge coupled device (CCD) as well as a lens or lenses. The driving unit 23 may be used to aim, focus, and zoom the lens 21 of the image capture device 2. In one embodiment, the driving unit 23 may be one or more driving motors.

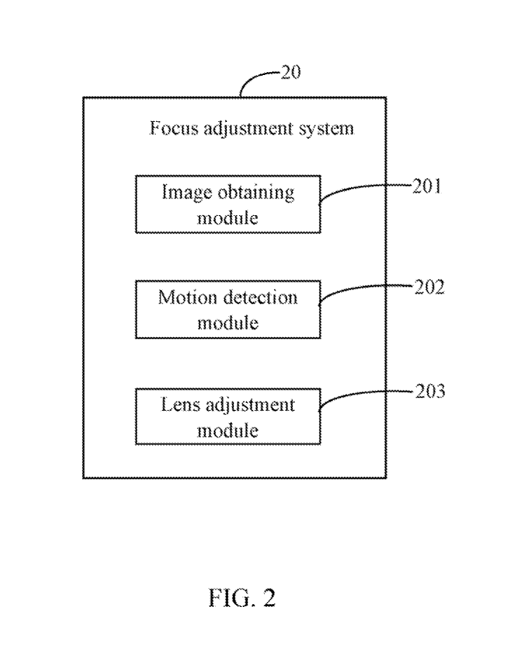

FIG. 2 is a block diagram of one embodiment of the focus adjustment system 20 of the image capture device 2. In one embodiment, the focus adjustment system 20 may include one or more modules, for example, an image obtaining module 201, a motion detection module 202, and a lens adjustment module 203. The one or more modules 201-203 may comprise computerized code in the form of one or more programs that are stored in the storage device 22 (or memory). The computerized code includes instructions that are executed by the at least one processor 24 to provide functions for the one or more modules 201-203.

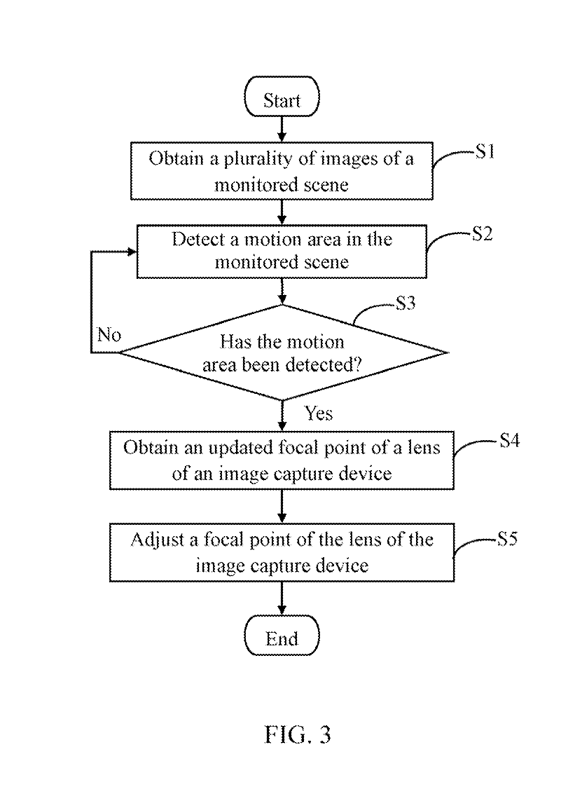

FIG. 3 is a flowchart of one embodiment of a method for adjusting the focal point of the lens 21 of the image capture device 2. Depending on the embodiment, additional blocks may be added, others removed, and the ordering of the blocks may be changed.

In block S1, the image obtaining module 201 obtains a plurality of images of a monitored scene captured by the lens 21. In one embodiment, the lens 21 captures an image of the monitored scene at preset time intervals (e.g., five seconds). It is to be understood that, the monitored scene is a motion scene when the image capture device 2 is moved. The monitored scene may be a bank vault or an enterprise confidential location where is needed to be monitored for security.

In block S2, the motion detection module 202 detects a motion area in the monitored scene from the obtained images. In one embodiment, the motion area is regarded as a moving object in the monitored scene. A detailed description is provided as follows.

First, the motion detection module 202 obtains a first image from the obtained images of the monitored scene at a first time, and calculates characteristic values of the first image. In one embodiment, the characteristic values of the first image are obtained by a fast Fourier transform of geometry characteristics, color characteristics, and/or texture characteristics of the first image.

Second, the motion detection module 202 obtains a second image from the obtained images of the monitored scene at a second time continuous with the first time, and calculates the characteristic values of the second image. In one embodiment, the characteristic values of the second image are obtained by the fast Fourier transform of geometry characteristics, color characteristics, and/or texture characteristics of the second image.

Third, the motion area detection module 202 compares the first image with the second image using autocorrelation of the characteristic values of the first image and the second image, and obtains a corresponding area in both of the first image and the second image. The autocorrelation is an image processing method of utilizing a correlation of characteristic values of two consecutive images (e.g., the first image and the second image) to find the corresponding area in both of the two consecutive images. In one embodiment, the corresponding area is an area appearing in both of the first image and the second image, and a correlation degree of the autocorrelation of the characteristic values of the first image and the second image falls in a range of [80%, 90%], for example. In other exemplary embodiments, the range of the correlation degree of the corresponding area can be modified and set according to requirements.

Fourth, the motion detection module 202 compares the characteristic values of the corresponding area in both of the first image and the second image, and obtains a motion area in the monitored scene according to differences in the characteristic values of the corresponding area in the first image and the second image.

In block S3, the motion detection module 202 determines if the motion area has been detected in the monitored scene. If the motion area has been detected in the monitored scene, the procedure goes to block S4. If the motion area has not been detected in the monitored scene, the procedure returns to block S2.

In block S4, the lens adjustment module 203 obtains an updated focal point of the lens 21 of the image capture device 2 according to the motion area. In one embodiment, the updated focal point of the lens 21 is a center of the motion area.

In block S5, the lens adjustment module 203 adjusts the focal point of the lens 21 of the image capture device 2 according to the updated focal point using the driving unit 23 to focus and zoom in on the lens 21 on the center of the motion area.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for adjusting a focal point of a lens of an image capture device, the method comprising:
obtaining a plurality of images of a monitored scene, the images being captured using the lens of the image capture device;
detecting a motion area in the monitored scene from the obtained images; and
adjusting a focal point of the lens of the image capture device to a specified position of the motion area upon the condition that the motion area has been detected.

2. The method according to claim 1, wherein the step of detecting a motion area in the monitored scene from the obtained images comprises:
obtaining a first image from the obtained images of the monitored scene at a first time, and calculating characteristic values of the first image;
obtaining a second image from the obtained images of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining a motion area in the monitored scene, according to differences in the characteristic values of the corresponding area in the first image and the second image.

3. The method according to claim 2, wherein the characteristic values of the first image or the second image are obtained by a fast Fourier transform of geometry characteristics, color characteristics, and/or texture characteristics of the first image or the second image.

4. The method according to claim 2, wherein the corresponding area is an area appearing in both of the first image and the second image, and a correlation degree of the autocorrelation of the characteristic values of the first image and the second image falls in a range between 80%-90%.

5. The method according to claim 1, wherein the specified position of the motion area is a center of the motion area.

6. An image capture device, comprising:
a lens;
a storage device;
at least one processor; and
one or more modules that are stored in the storage device and are executed by the at least one processor, the one or more modules comprising instructions:
to obtain a plurality of images of a monitored scene, the images being captured using the lens of the image capture device;
to detect a motion area in the monitored scene from the obtained images; and
to adjust a focal point of the lens of the image capture device to a specified position of the motion area upon the condition that the motion area has been detected.

7. The image capture device according to claim 6, wherein the instruction to detect a motion area in the monitored scene from the obtained images comprises:
obtaining a first image from the obtained images of the monitored scene at a first time, and calculating characteristic values of the first image;
obtaining a second image from the obtained images of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining a motion area in the monitored scene, according to differences in the characteristic values of the corresponding area in the first image and the second image.

8. The image capture device according to claim 7, wherein the characteristic values of the first image or the second image are obtained by a fast Fourier transform of geometry characteristics, color characteristics, and/or texture characteristics of the first image or the second image.

9. The image capture device according to claim 7, wherein the corresponding area is an area appearing in both of the first image and the second image, and a correlation degree of the autocorrelation of the characteristic values of the first image and the second image fall in a range between 80%-90%.

10. The image capture device according to claim 6, wherein the specified position of the motion area is a center of the motion area.

11. A non-transitory storage medium having stored thereon instructions that, when executed by a processor of an image capture device, causes the processor to perform a method for adjusting a focal point of a lens of the image capture device, the method comprising:
obtaining a plurality of images of a monitored scene, the images being captured using the lens of the image capture device;
detecting a motion area in the monitored scene from the obtained images; and
adjusting a focal point of the lens of the image capture device to a specified position of the motion area upon the condition that the motion area has been detected.

12. The non-transitory storage medium according to claim 11, wherein the step of detecting a motion area in the monitored scene from the obtained images comprises:
obtaining a first image from the obtained images of the monitored scene at a first time, and calculating characteristic values of the first image;
obtaining a second image from the obtained images of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining a motion area in the monitored scene, according to differences in the characteristic values of the corresponding area in the first image and the second image.

13. The non-transitory storage medium according to claim 12, wherein the characteristic values of the first image or the second image are obtained by a fast Fourier transform of geometry characteristics, color characteristics, and/or texture characteristics of the first image or the second image.

14. The non-transitory storage medium according to claim 12, wherein the corresponding area is an area appearing in both of the first image and the second image, and a correlation degree of the autocorrelation of the characteristic values of the first image and the second image fall in a range between 80%-90%.

15. The non-transitory storage medium according to claim 11, wherein the specified position of the motion area is a center of the motion area.

16. The non-transitory storage medium according to claim 11, wherein the medium is selected from the group consisting of a hard disk drive, a compact disc, a digital video disc, and a tape drive.
